(19) United States
(12) Patent Application Publication
(10) Pub. No.: US 2005/0247501 A1
(43) Pub. Date: Nov. 10, 2005

(54) Decorative motorcycle coverings

(76) Inventor: Michael C. Baker, Upper Marlboro, MD (US)

Correspondence Address: National IP Rights Center, LLC, Suite 400, 550 Township Line Road, Blue Bell, PA, 19422, US

(21) Appl. No.: 11/124,889

(22) Filed: May 9, 2005

Related U.S. Application Data
(60) Provisional application No. 60/569,199, filed on May 7, 2004.

(51) Int. Cl. B62D 61/02

(52) U.S. Cl. 180/219; 150/167

(57) ABSTRACT

A decorative covering for a motorcycle is disclosed. The covering comprises a material which is affixed to the cycle. The material may comprise a leather, cloth, plastic or sheet polymer. The materials have decorative designs. The material may be attached or affixed by velcro, snaps or adhesives.

### CROSS REFERENCE TO RELATED APPLICATIONS

This application claims benefit to provisional application 60/569,199, filed on May 7, 2004, entitled “Decorative Motorcycle Coverings”, which is incorporated by referenced herein it its entirety.

### FIELD OF THE INVENTION

The present invention is directed to the field of cloth or similar coverings for motorcycles and the like. In particular, the present invention is a novel covering system which changes the appearance of motorcycle parts and components without painting or other non-destructive process.

### BACKGROUND OF THE INVENTION

Motorcycles have gained great popularity since the end of the Second World War. Typically, motorcycles have been covered by chrome and enamel paint, similar to that a car. A number of instrumentalities have been used to decorate motorcycles, including decals and the like.

The patent literature discloses several patents directed to motorcycle design systems and apparatus. U.S. Pat. No. 5,884,380 discloses a motorcycle gas tank cover comprising a sheet of material shaped to cover a stock gas tank to modify the appearance of the size and shape of the tank. The gas tank cover is attachable to the gas tank by connectors and fasteners which secure the gas tank in place. The appearance of the gas tank is modified without removing or replacing the gas tank. The present invention provides a method and apparatus to frequently modify the appearance of a motorcycle gas tank and the total look of the motorcycle that does not require replacing any motorcycle parts.

U.S. Pat. No. 5,575,528 discloses a motorcycle seat having an arcuate rear portion and a front portion. A fender cover is fixed to the arcuate rear portion of the motorcycle seat and extending rearwardly therefrom. The fender cover comprises a thin section conforming generally to the contour of the upper portion of a motorcycle fender and including a base plate and a decorative top.

U.S. Pat. No. 4,469,256 discloses a vehicle frame element cover apparatus which includes a flexible shell adapted to be snugly fit about the frame element and held in proper orientation by an adjustable strap and pockets which receive portions of the frame element. Zippered slits are formed in the shell to allow convenient attachment of the cover to the frame element and, when the slits are closed, the cover is drawn taut around the frame element. Preferably, the shell is formed from an inner layer of soft material and an outer layer of durable, wear-resistant material. Removable pouches may be mounted on the shell.

U.S. Pat. No. 5,109,942 discloses a vehicle body cover includes a fairing outer and a fairing inner mounted onto the fairing outer. An instrument panel is supported by the fairing inner. Left and right side panels each have an inner wall with an upper rim, and an outwardly extending flange attached to said fairing outer. A top cover overlies and connects to the upper rims of the side panels, and has arms attached to the fairing inner.

U.S. Pat. No. 4,676,518 discloses a dust cover adapted for sealing the opening extant between a fork tube and its attendant fork slider on a telescopic motorcycle fork assembly is disclosed. The cover includes a casing fabricated from materials which are resistant to the environment. The casing is mounted on an end of the slider and includes an interior channel dimensioned to slidably receive a portion of the fork tube which extends outward from that slider. The casing is fitted with a sealing means which extends into the interior channel and abuts against the fork tube so as to form a tight seal.

U.S. Pat. No. 6,641,225 discloses a decorative tire sidewall shield cover that provides the tire sidewall with added beauty and protection. The device is a substantially planar ring-like member having a central aperture substantially of the same diameter as the wheel or hub opening of the tire. The decorative sidewall shield can also have a centrally disposed flange or lip that will be positioned between the tire rim and wheel rim being held in place by tire air pressure. In addition to an exterior shield for tires such as motor vehicles, the tire shield covers both sides of a tire, such as for a motorcycle. The material used would have abrasion resistance properties.

U.S. Pat. No. 6,231,104 to Roethel discloses a removable shield for deflecting wind and projectile objects from the front of a vehicle such as a motorcycle or bicycle. The shield comprises a flexible material that is sized to cover a portion of the front of the motorcycle or bicycle and is located from between the handlebar down to the front fender, or front forks. The shield is attached by elastomeric cords and hooks, or other suitable fastening device to the handlebars and front fender or front forks.

U.S. Pat. No. 5,490,549 discloses a fuel tank cover to temporarily cover the top and sides of the fuel tank of a motorcycle. The fuel tank cover has an upper panel that is solid and intended to cover the entire upper portion of the fuel tank. Two side panels are adapted to snugly cover the sides of the fuel tank and a forward panel member is adapted to cover the forward portion of the fuel tank.

While there have been a number of patents directed to motorcycle decoration devices and systems, none are directed to a system for easily applying new and ornamental designs to a motorcycle as part of an overall design.

It would be desirable to provide a system for easily decorating a motorcycle.

It is a principal object of the present invention to provide a novel system for decorating a motorcycle.

It is a further object of the invention to provide a system which can be applied by an adhesive, velcro or other attachment system.

It is yet a further object of the present invention to provide a decorating system which can be sized for specific cycles.

These and other objects of the present invention will become apparent from the detailed description which follows.

### SUMMARY OF THE INVENTION

A decorative covering for a motorcycle comprising: a covering section pre-sized to fit over a pre-selected section of a motorcycle; and means to adhere the covering section over the pre-selected section. The adhering means may comprises Velcro, snaps or an adhesive

In a further embodiment, the invention is a decorative covering for a motorcycle comprising: a cloth or polymer covering section pre-sized to fit over a pre-selected section of a motorcycle; and adhesive means to adhere the covering section over the pre-selected section.

In still a further embodiment, the invention is a decorative covering for a motorcycle comprising: a plurality of cloth or polymer covering sections pre-sized to fit over a plurality of pre-selected sections of a motorcycle; and adhesive means to adhere the covering sections over the pre-selected sections. The pre-selected sections may comprise at least the fuel tank, front and rear fenders, side panels, and other body parts.

### BRIEF DESCRIPTION OF THE FIGURES

FIG. 1 illustrates the present invention in a first embodiment.

FIG. 2 illustrates the present invention as applied to a cycle fender.

FIG. 3 illustrates a kit for the present invention.

FIG. 4a-4e illustrates alternative embodiments of the coverings.

### DETAILED DESCRIPTION OF THE PREFERRED EMBODIMENT

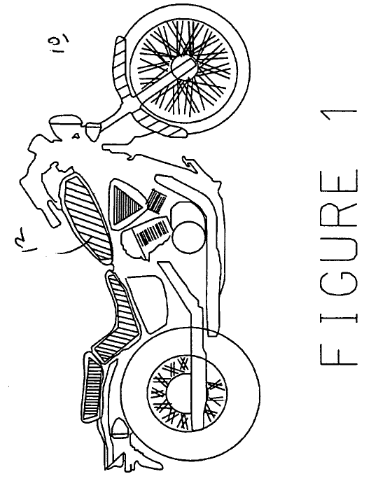

The present invention is directed to a system which permits a motorcycle to be covered or decorated with a decorative cloth covering or similar decoration. Referring to FIG. 1, the invention 10 comprises a leather, cloth, Lycra, polymer or similar cover. As shown the coverings may be sized and adapted to be applied to any section of a motorcycle. While the invention is shown in the context of a motorcycle, it is to be appreciated that the teachings of the present invention are applicable to a number of similar vehicles including mopeds, bicycles, ATVs and even jet skis.

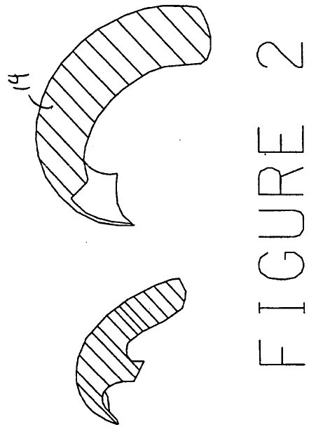

As shown in FIGS. 1 and 2, the coverings may be applied by means of Velcro, snaps, or adhesives. Different sized coverings can be applied to the motorcycle to provide it with a highly decorative covering. Coverings can be designed to cover the gas tank, front and rear fenders, other body panels, and cargo bags as well as the space surrounding the engine.

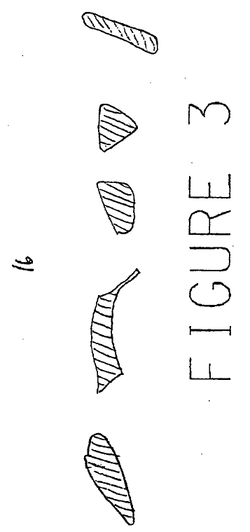

The present invention can be configured and sized to cover specific cycles and models. For example, covering can be designed for specific Honda, Yamaha, Suzuki and Harley Davidson models Referring to FIG. 3, a pre-selected kit can be sold containing a plurality of designs.

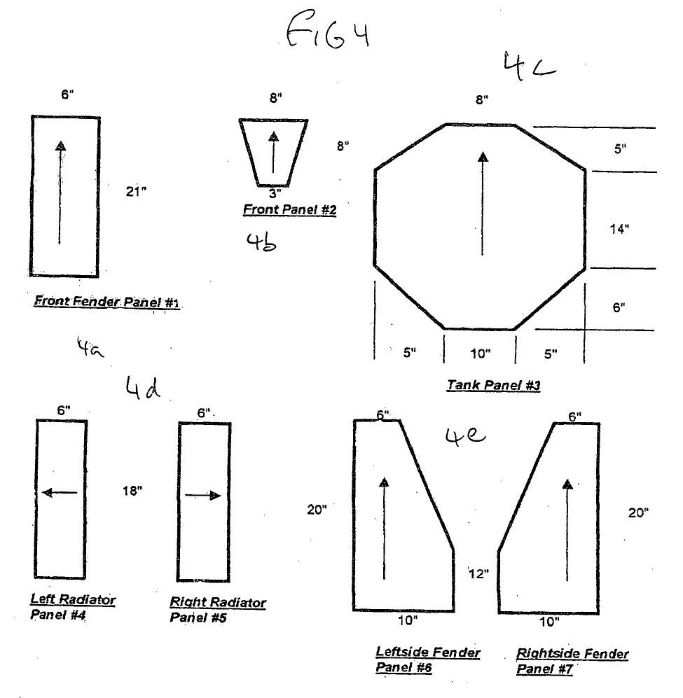

FIGS. 4a-4d illustrate yet additional embodiments. As shown, the covering can cover the front fender panel, front panel, trunk panel, left/right radiator and left/right fender panel.

These and other features objects of the invention will become apparent from the claims which follow.

1. A decorative covering for a motorcycle comprising:
a covering section pre-sized to fit over a pre-selected section of a motorcycle; and
means to adhere the covering section over the pre-selected section.

2. The decorative covering for a motorcycle of claim 1 wherein the adhering means comprises Velcro.

3. The decorative covering for a motorcycle of claim 1 wherein the adhering means comprises an adhesive

4. The decorative covering for a motorcycle of claim 1 wherein the covering comprises one of a leather, polymer or cloth fabric.

5. The decorative covering for a motorcycle of claim 1 wherein the covering is pre-sized for a specific motorcycle.

6. A decorative covering for a motorcycle comprising:
a cloth or polymer covering section pre-sized to fit over a pre-selected section of a motorcycle; and
adhesive means to adhere the covering section over the pre-selected section.

7. A decorative covering for a motorcycle comprising:
a plurality of cloth or polymer covering sections pre-sized to fit over a plurality of pre-selected sections of a motorcycle; and
adhesive means to adhere the covering sections over the pre-selected sections.

8. A decorative covering for a motorcycle of claim 7 wherein the pre-selected sections comprise at least the fuel tank, front and rear fenders and other body panels.
